(19) United States
(12) Patent Application Publication
(10) Pub. No.: US 2013/0332406 A1
(43) Pub. Date: Dec. 12, 2013

(54) Method and System for Modeling Consumer Behavior Using N-Dimensional Decision Factor Categorization with Quantifiers and Qualifiers

(71) Applicant: WUHU, LLC, Merrimack, NH (US)

(72) Inventors: Terry K. Gilliam, Wickford, RI (US); Rob Maille, Acton, MA (US); Burc Oral, Lexington, MA (US)

(21) Appl. No.: 13/905,450

(22) Filed: May 30, 2013

Related U.S. Application Data
(60) Provisional application No. 61/653,572, filed on May 31, 2012.

(51) Int. Cl. G06N 5/02

(52) U.S. Cl. CPC G06N 5/02
USPC 706/52

(57) ABSTRACT

The system and method for modeling consumer behavior uses n-dimensional decision factor categorization of travel qualifiers and quantifiers to provide the user with only the most relevant results for each query by matching numerous variables to a user's behavior to learn about the user, remember the user, and ultimately predict further behavior of a user.

### CROSS-REFERENCE TO RELATED APPLICATIONS

The present application claims the benefit of Provisional Patent Application Ser. No. 61/653,572 filed May 31, 2012, which is incorporated herein by reference.

### FIELD OF THE INVENTION

The present invention relates to a method and system for modeling consumer behavior. More particularly, it relates to a method and system for modeling consumer behavior for travel planning using n-dimensional decision-factor categorization of travel descriptors as qualifiers and quantifiers.

### BACKGROUND OF THE INVENTION

Travel planning can be a very labor-intensive and time-intensive experience. While having numerous choices at one's fingertips is often seen as a plus, when it comes to planning a trip, having numerous choices can very quickly to into a negative. There are countless variables that a user needs to consider when planning a trip, and this is complicated further when a user attempts to plan activities to enjoy when lie ultimately arrives at his destination(s).

A user must decide when to travel (night/day, weekend/weekday, etc.), how to travel (air/water/land/combination, to the closest hub/to a cheaper hub with car rental/taxi/subway, economy/business/first class, etc.), and where to stay (vacation rental/B&B/hotel/motel, etc.). A user might have budgetary concerns, or not. He might be traveling with a limited budget or an unlimited budget. Currently, all of these considerations, and more, are layered on top of all the choices of carriers and accommodations making trip planning a major undertaking.

Currently, online travel planning begins with a user who is presented with an enormous selection of choices available through a Global Distribution System (“GDS”). A GDS is a collection that enables searching and booking on major vendors including several thousand hotels, and several hundred airlines and major transportation providers for car rentals, trains, and the like. This enormous body of information is presented to the user and the user must manually sort through all the data. This is not only time-intensive, but is labor-intensive and confusing.

The system and method of the present invention creates a time-saving and more pleasant experience for the user by providing the user with only the most relevant results for each user query by matching numerous variables to a user's behavior to learn about the user, remember the user, and ultimately predict further behavior of the user.

### SUMMARY OF THE INVENTION

One aspect of the present invention is a system for modeling consumer behavior comprising an input mechanism configured to receive and send user-related information; a central processing unit configured to receive and send user-related information and supply data relating to travel and entertainment, wherein the central processing unit comprises a scoring engine and at least one database for storing information relating to travel and entertainment; a scoring engine configured to categorize user-related information based on decision models and compare the categorized user-related information to the information stored in the at least one database thereby creating a list of results; and an output mechanism configured to receive and display the list of results, wherein the user selects a result to add to a journey.

In one embodiment of the present invention, the input mechanism comprises a computing device.

In one embodiment of the present invention, the output mechanism comprises a computing device.

In one embodiment of the present invention, the central processing unit is configured to update and store the journey and related information from search to purchasing.

In one embodiment of the present invention, the central processing unit is configured to notify the user of gaps in the journey via the output mechanism.

In one embodiment of the present invention, the central processing unit is configured to provide a list of possible results to fill a gap in the journey.

In one embodiment of the present invention the scoring engine comprises a scoring function selected from the group consisting of a passive decision model approach, an active decision factor approach, and a coordinated multi-factor approach.

In one embodiment of the present invention, the scoring function comprises a passive decision model approach.

In one embodiment of the present invention., the scoring function comprises an active decision model approach.

In one embodiment of the present invention, the scoring function comprises a coordinated multi-factor approach.

In one embodiment of the present invention, the scoring function comprises the WUHU score and confidence level.

In one embodiment of the present invention, the WUHU score and confidence level uses realized, transient, bootstrapping, rewards, and direct behavior values to evaluate a result.

In one embodiment of the present invention, the direct behavior comprises options ranging from like-it, hate-it, exclude-it-forever, make-it-default, hide-it, and the like, wherein the designations map into an importance value scale between −1 and 1.

In one embodiment of the present invention, the decision models are selected from the group consisting of an initial set, C3, T9, B5 and I8.

In one embodiment of the present invention, the C3 decision model comprises cost, comfort, and convenience.

In one embodiment of the present invention, the T9 decision model comprises location, cost, time, brand, amenity, service class, service type, rating, and convenience.

In one embodiment of the present invention, the B5 decision model comprises vendor, cost, location, time. and service class.

In one embodiment of the present invention, the I8 decision model comprises cost, location, climate, time, recreation, occasion, environment, and relation.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a table of venues and associated attributes of an embodiment of the present invention.

FIG. 2 is a graphical representation of qualifiers, including attributes and their associated values of an embodiment of the present invention.

FIG. 3 is a graphical representation of the relationships between attributes, values, and behaviors of an embodiment of the present invention.

FIG. 4 is a graphical representation of some sources of behavior of an embodiment of the present invention.

FIG. 5 is a graphical representation of behavior capture for a behavior type of an embodiment of the present invention.

FIG. 6 is a table of behavior type data gathered for an embodiment of the present invention.

FIG. 7 is a table of decision factors and some associated impressions used in a decision model of an embodiment of the present invention.

FIG. 8 is a graphical representation of the relationship between elements of a decision model in an embodiment of the present invention.

FIG. 9 is a graphical representation showing the use of bootstrap questions in an embodiment of the present invention.

FIG. 10 is a graphical representation showing the relationships between elements of an embodiment of the present invention used to capture behavior.

FIG. 11 is a table showing an example of the translation of qualifiers to quantifiers in an embodiment of the present invention.

FIG. 12 is a representation of active and passive decision factor model approaches of embodiments of the present invention.

### DETAILED DESCRIPTION OF THE INVENTION

The system and method of modeling consumer behavior for travel planning utilizes n-dimensional decision factor categorization of travel descriptors as quantifiers and qualifiers to enable users to rank their purchases and reduce processing time. This system and method for modeling consumer behavior is relevant to many different commercial applications but will be discussed in terms of travel planning for simplicity.

This system and method for modeling consumer behavior is configured to learn about the user in order to model the user so that the travel-related planning efforts of the user can be minimized. The system and method learns about the user by capturing behavior. Behavior capture can be comprised of gathering data from the user, or other sources, and then by describing the user's behavior in terms of qualifiers. A qualifier consists of an attribute and associated value(s). Once the user's behavior has been mapped to several relevant qualifiers, the user can be modeled using several different decision models. In addition to using different decision models, including C3, B5, T9 and I8, the user's behavior can be modeled using quantifiers. A quantifier consists of a decision factor and an associated impression.

The challenge in travel-related consumer modeling is knowing enough about the user to be able to provide the user with a time-saving and more Pleasant travel planning experience. This system and method of consumer modeling matches a user's behavior to recommended results in either an active (quantifier-based) approach or a passive (qualifier-based) approach. Ultimately, consumer modeling will enable behavior prediction for use in future travel-related planning.

Generally speaking, each travel-related product is related to a set of qualifiers. Qualifiers consist of an attribute and the associated value or values. For example, for the travel-related product fly, carrier is an attribute, and United Airlines is a value. Qualifiers are modifiers that define travel. These qualifiers can be applied over a wide range of “travel-related” products ranging from lodging, airfare, ground and water transportation, restaurants, recreational activities, cruise, events, entertainment, and the like.

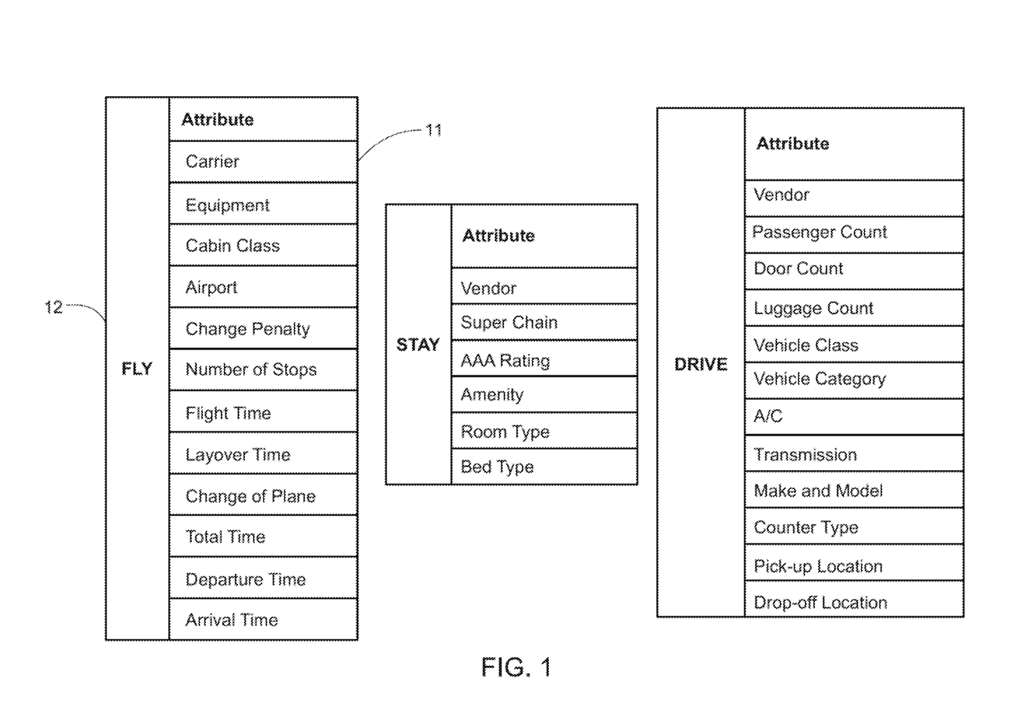

In FIG. 1, there are a few examples of travel-related products, or venues, 12, which are shown with a few of their related attributes 11. Each of these attributes would have associated value(s), not shown. A venue is a broad designation of a travel activity. The venue fly for instance designates, helicopter, charter flights, and commercial flights. The venue stay designates hotels, bed and breakfasts, camping sites.

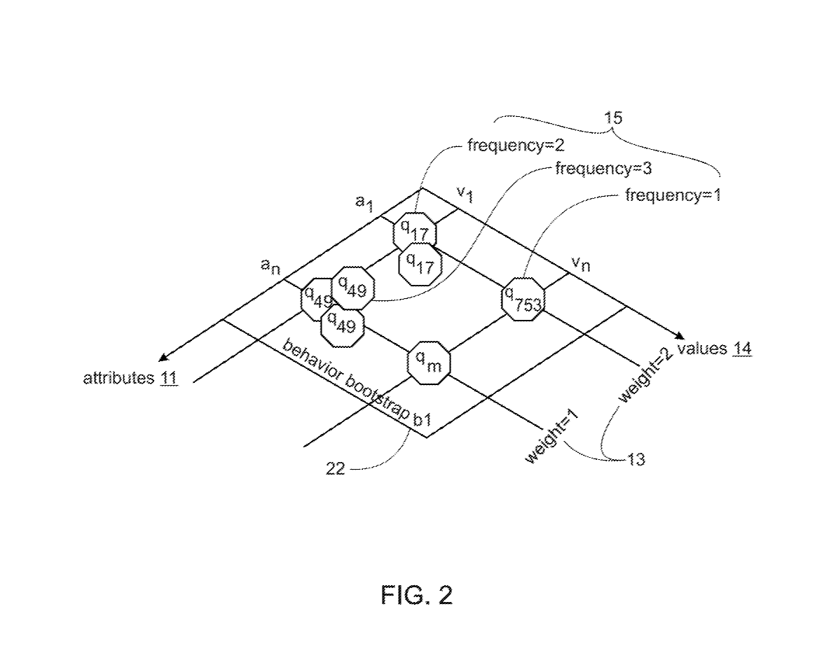

There are journey attributes and package attributes. There can be several different attribute types including simple, compound, derived, and relative. Examples of a simple attribute are airline carrier or operator. A compound attribute is obtained by combining one or more simple attributes. A derived attribute is a descriptor that is not inherent in the travel system but can be used to model consumer behavior and affect choices. A relative attribute defines a travel system in relation to an overall set of values, such as cheapest fare. The value(s) associated with an attribute can also vary and may include single-value (a hotel chain name, airline equipment), multi-value (range) (zero to two stops, two to four doors) or multi-value (tolerance) (cost is x plus or minus y, distance is x plus or minus y). These attributes and values are coupled to represent a set of qualifiers. A qualifier is an attribute and a value or an attribute and multiple values. In a range value the first value is the lower limit and the second value is the higher limit. In tolerance value type, the first value is the central value and the second. value is the plus or minus variation. In FIG. 2, there is a plot of qualifiers showing that qualifier q17 is a combination of attribute a1 and value v1. Attribute a2 has a weight of 2. The qualifier q17 occurs twice thus it has a frequency of 2. Qualifier q753 is made up of attribute a1 and value Vn and has a frequency of one. In FIG. 2, attributes 11 have weights 13 and the associated values 14 have frequencies 15. FIG. 2 shows some of the qualifiers associated with one behavior type 22, bootstrapping. These qualifiers are shown for a bootstrapping behavior.

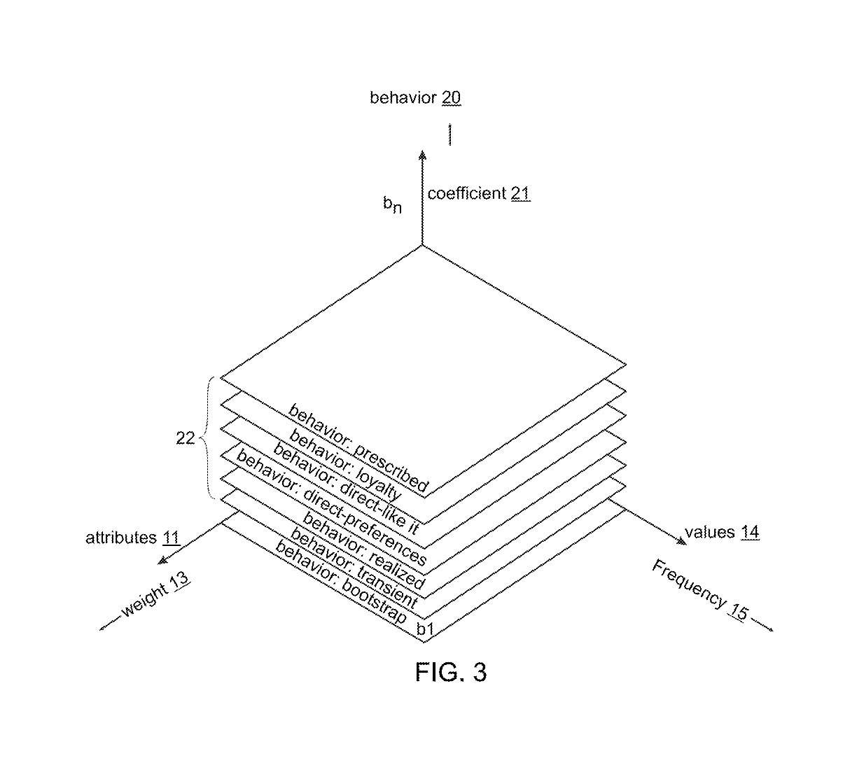

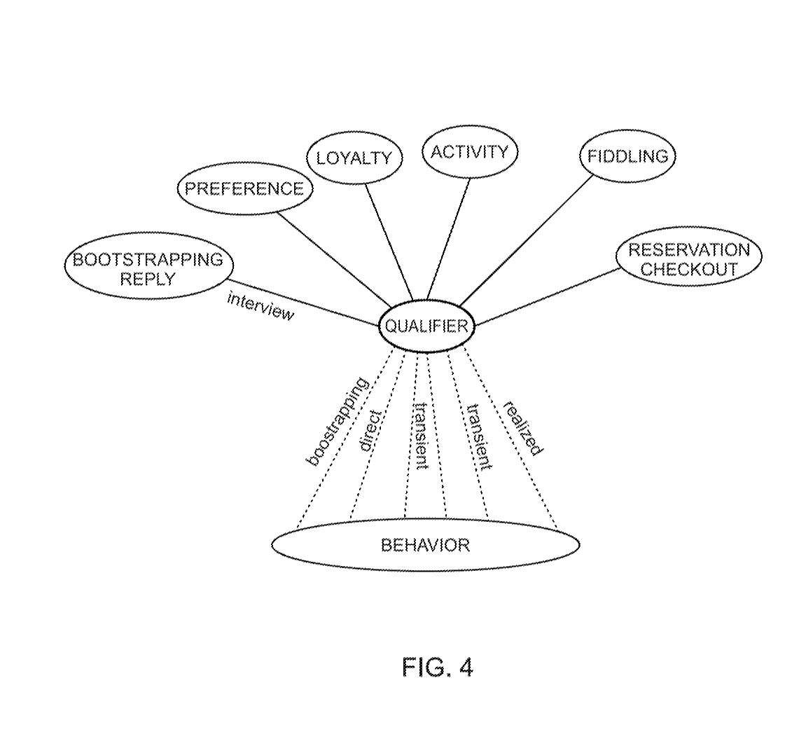

In FIG. 3, layers of behavior, or behavior types, are represented by showing that behaviors 20 have coefficients 21 and that one behavior is only different from another by its classification. They may or may not use the same set of qualifiers. Each behavior qualifier has a coefficient that indicates its overall importance in regard to others. As shown in FIG. 3, a behavior 20 is a choice of a qualifier 10 under a certain condition, which can be defined as a behavior type 22. A behavior type can include direct (choices and entry), transient, realized, rewards, or bootstrapping. Again, qualifiers 10 are shown as attributes 11 which have weights 13 and the associated values 14 which have frequencies 15. See also, FIG. 4 for a representation of some of the various sources of behavior. Initially, the source of behavior is boot strapping. This is used to seed the direct behavior (choice, in diagram preferences). Next source is the rewards (shown as loyalty in the diagram). Other dynamic sources of behavior are fiddling (a transient behavior), selections made by the user (activity) and finally checkout, which finalizes the traveler behavior.

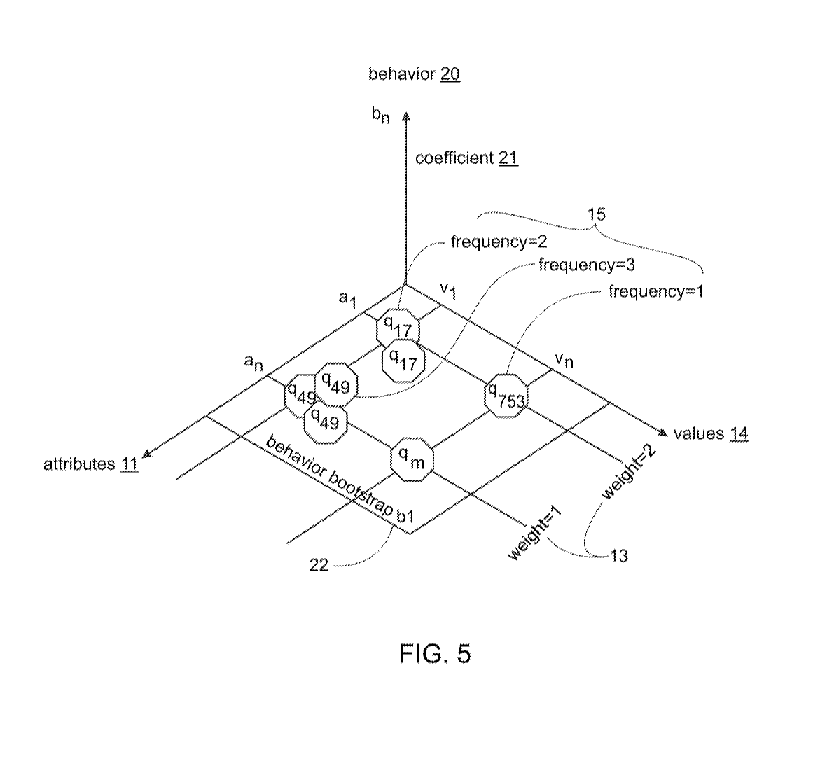

In FIG. 5, one behavior type 22, bootstrapping, is shown for simplicity. The behavior type is shown with the related qualifiers 10, which consist of attributes 11 which have weights 13, and the associated values 14 which have frequencies 15.

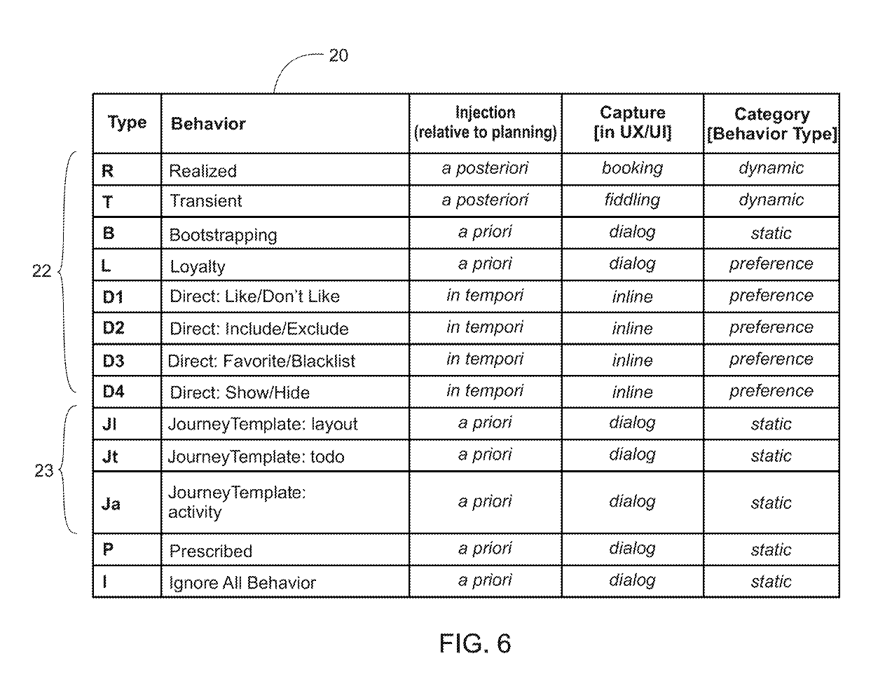

In FIG. 6, some of the various behavior types 22 are shown. As the table demonstrates, both bootstrapping and loyalty behavior types are injected earlier in the planning process than direct behaviors. The last of the behavior types to be injected are the transient (fiddling) and realized behavior. Also shown are journey templates 23, which will be discussed in more detail below. Prescribed behavior covers repeat journeys, and shared journeys. For instance, a traveler wanting to repeat his last journey requires the travel qualifiers being prescribed not by overall behavior but by a behavior specific to a journey. Similarly, sharing a journey (inviting another traveler to a journey) will require the invitee to make decisions based on the inviter's defined journey qualifiers.

Each qualifier can be translated into a set of quantifier. A quantifier consists of a decision factor and an associated impression. A quantifier is a modifier that indicates the quantity; a measure of a decision factor. A quantifier can be non-linear and overlapping. A decision factor is an aspect or element that contributes to a particular result. And, the associated impression is an effect, feeling, or image retained as a consequence of experience. For example, comfort is a quantifier, and an associated impression might be luxurious or basic. Impressions are subjective. Typically, they are adjectives that evoke the right affect, and they offer greater latitude for interpretation. Impressions are implicit descriptors for quantifiers to reflect subjectivity. Some examples of impressions might also include high, low, very, not at all, expensive, fair, affordable, and the like.

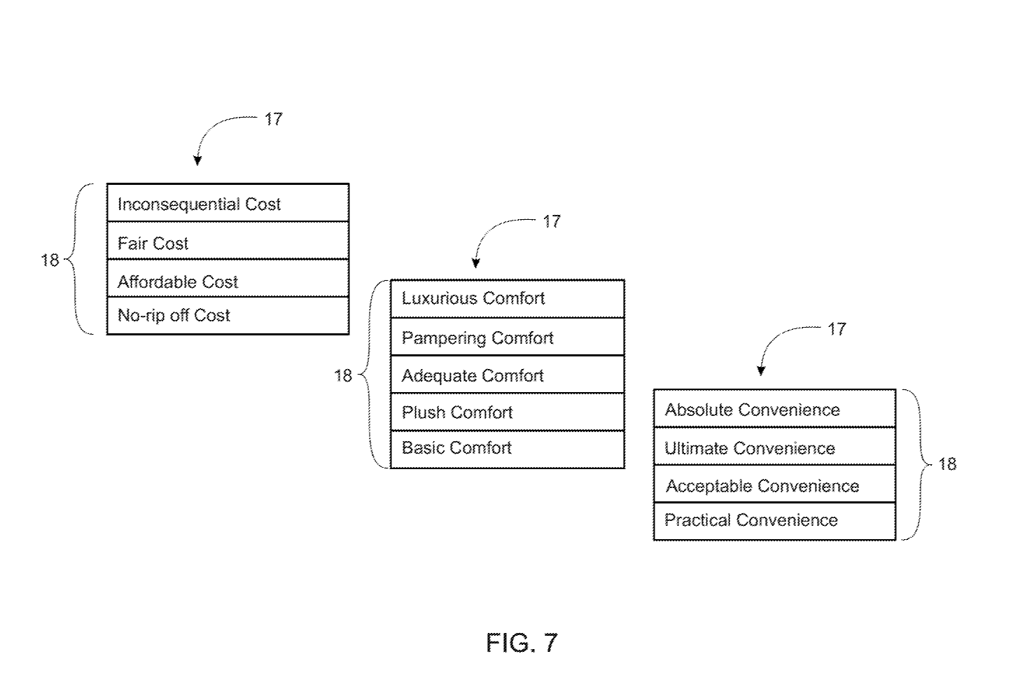

In FIG. 7, several decision factors 17, cost, comfort and convenience, are shown with some possible associated impressions 18, such as luxurious, adequate, and basic. These decision factors 17 are part of the C3 decision factor model 16, Which will be discussed in greater detail below.

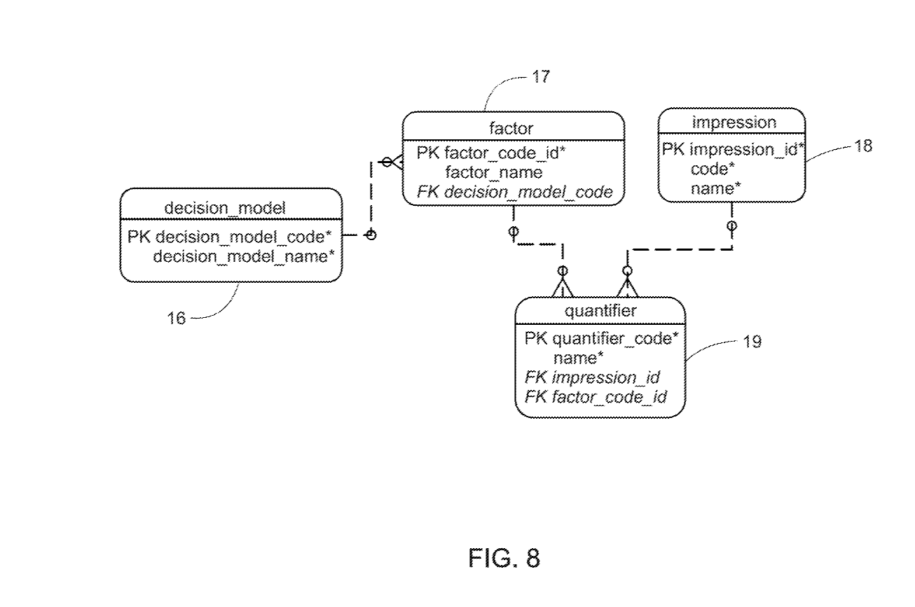

In FIG. 8, the flowchart represents the relationships between decision models 16, decision factors 17, impressions 18 and quantifiers 19.

The system and method of consumer modeling is all about “knowing the traveler.” In order to be able to model the traveler and minimize the traveler's planning efforts. To know the traveler, the system and method incorporates the ability to learn about the user's behavior.

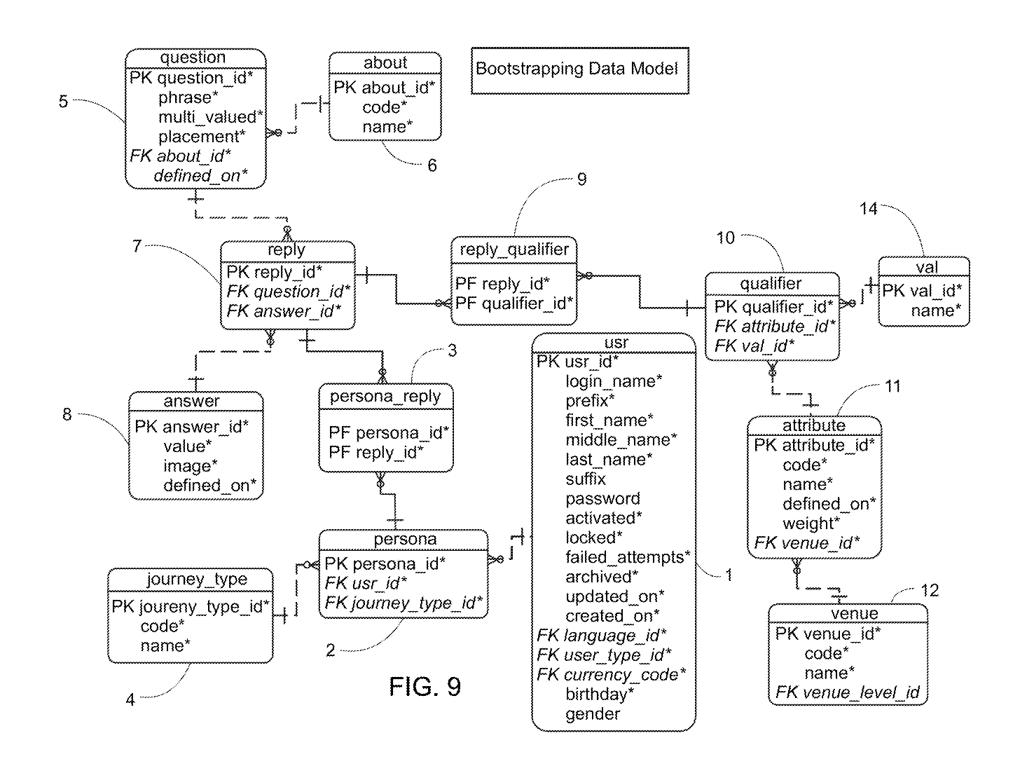

As seen in FIG. 9, one way of learning about the user is through bootstrapping. Bootstrapping is a technique of assigning the first few qualifiers 10 to a traveler 1. Bootstrapping uses the past behavior of a traveler, which can be determined in several ways. First, the user can manually provide pertinent information by answering a few questions 5. The questions can be mapped into a set of qualifiers 10, which describe a certain aspect of a travel-related product. Depending on the sophistication of the questions asked, several qualifiers may be mapped from one reply, not shown. For example a simple question could be “which airline do you want to use?” A more complex question might be “do you want to travel like a king?” The later question maps to a multitude of qualifiers, which relate to several quantifiers such as cost, comfort, and convenience, not shown. Second, a traveler could provide information via an old itinerary, which could be mapped to a set of qualifiers. Third, the traveler could provide a locator code from previous a previous trip and the system and method of consumer modeling could pull information stored in the GDS to map to a set of applicable qualifiers.

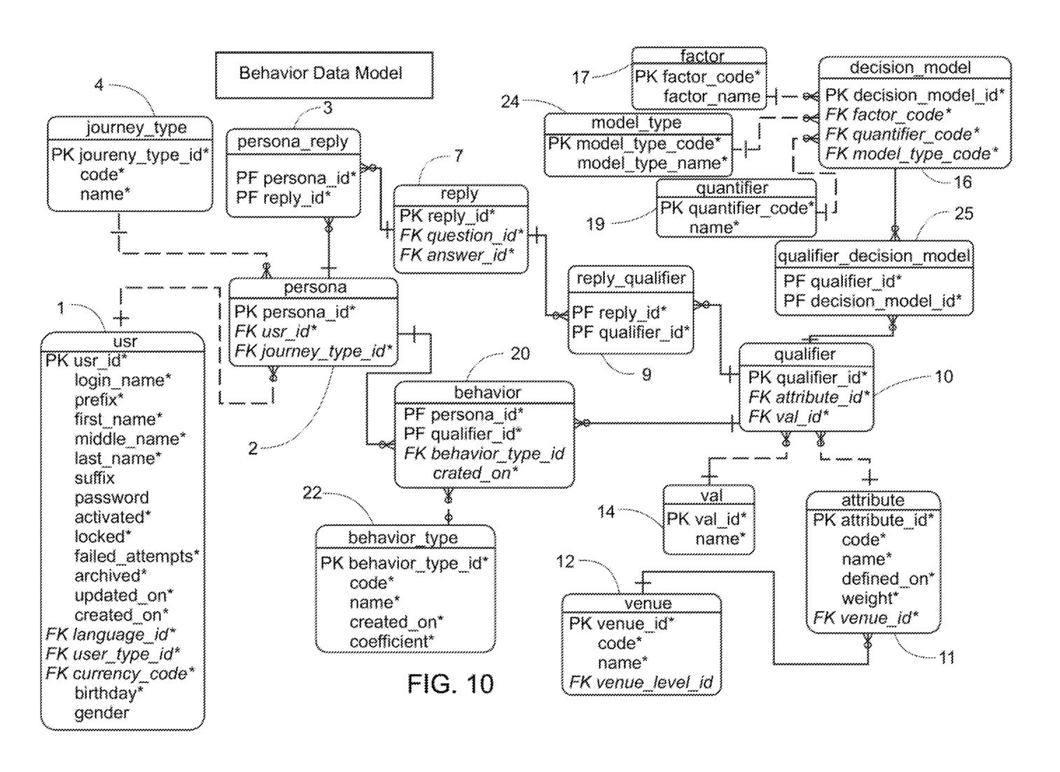

In FIG. 10, behavior can be captured with qualifiers using a series of questions that map into qualifiers. Every question and answer is a reply that corresponds to one or more qualifiers.

In addition to bootstrapping, another way of capturing a user's behavior is by classifying. Classifying can be accomplished using realized behavior (e.g. a particular product was booked), direct behavior, or fiddling. Examples of a direct behavior type could be favorite (like-it), blacklist (hate-it), exclude-it-forever, make-it-default, hide-it, and the like. Lastly, fiddling is an example of transient behavior. Fiddling can occur at either the qualifier level or the quantifier level. For example, at the quantifier level, the user may say “cost doesn't matter,” and at the qualifier level, the user may say “I only want 4 star properties.” The applicable qualifiers can be translated into quantifiers, and vice versa.

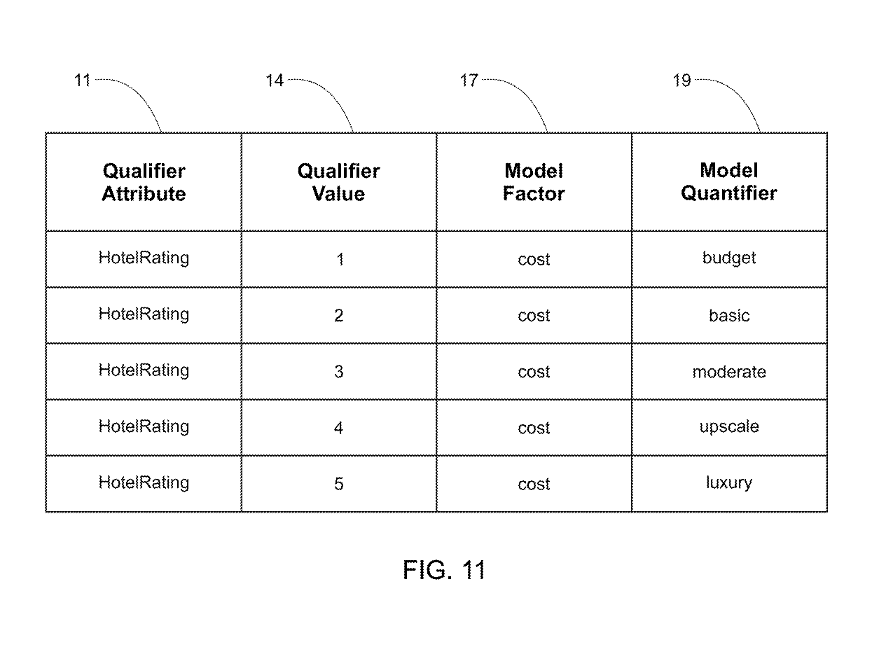

In FIG. 11 there is an example of how a qualifier 11 can be translated into a quantifier 19. The attribute 11 and associated value(s) 14 for a qualifier 11 are abstracted via a decision factor model 16. As seen in FIG. 8, the decision factor model 16 relates to the quantifier 19 via the decision factor 17 and the associated impression 18. This translation could also happen from quantifier 19 to qualifier 11.

Travel is defined as a chronologically-based journey. The system and method of consumer modeling comprises a scoring engine and a time planner to manage activities that are chosen and scored (with confidence levels), as a way at arriving at a user's travel itinerary. The system matches numerous qualifiers to a user's behavior to learn about the user, remember the user, and ultimately predict further behavior of a user. This system and method creates a time-saving and more pleasant. experience for the user by providing. the user with only the most relevant data for a given choice.

To fully-describe a user the system and method must get to know the user. Ideally, the system and method will be able to predict future behavior by the user. By bootstrapping, the system and method of consumer modeling can approximate the user's behavior at about a level defined by the coefficient for bootstrapping. A user's loyalty to a particular provider can account for about 10%. The consumer's ability to fiddle (e.g. the user fine-tunes the results) can provide about another 20%, and the final about 10% comes from realized behavior (e.g. the user selected a particular result).

Consumer behavior can be collected over time by recording how and when a user chooses a particular qualifier. A certain purchase item may be recommended to a consumer just because that item has certain qualifiers. This can be represented by a score in relation to the entire qualifier set, and/or in relation to other categories. A score is obtained when there is a direct occurrence of a qualifier in a travel result. A score can also be indirectly obtained when a quantifier encompasses a travel record. This is achieved through qualifier and quantifier mapping.

The system and method of consumer modeling accommodates certain purchasing behaviors by capturing and weighing a user's over-arching decision drivers, weighs the success of past trips, if available, and tailors a user's results to suit the user's interests. This allows users the flexibility to change their mind, without being overwhelmed by countless volumes of irrelevant hits. This scoring of purchase items reduces the consumer's process time considerably.

Another important feature of this method and system of consumer modeling is the ability to understand the gaps between a user's expressed behavior and a user's actual behavior. One feature is the ability to measure how much is known about the user. The system and method of consumer modeling comprises behavior and decision model. metrics. There are several behavior metrics that can be applied initially and on a continuing basis. For example, an initial bootstrapping metric might evaluate the question and reply coverage, or the reply density and magnitude. The coverage would evaluate how closely a question or reply maps to attributes, for example. The behavior metric applied on a continuing basis could evaluate attribute coverage, or qualifier density and magnitude. Some decision model metrics include decision factor coverage, quantifier density and magnitude, factor isolation by significance, and quantifier coalescence.

The use of metrics will help to minimize gaps in understanding the user. Some of the categories which tend to manifest as gaps include price, proximity, time, and the like. This is due, in part, because these categories tend to be modeled best by step functions, as they do not have a mean value. For example, cost as it pertains to transportation is linked. to the time of day, the number of stops, etc. Thus, there may be an expensive flight (non-stop) and an inexpensive flight (2 stops), but there may not be a stop having a cost in between the two. Another example of a gap in understanding is if a user selects “affordable” in reference to an accommodation. The method and system may initially interpret that to mean a Red Roof Inn, but the user may classify Marriott as affordable. Once a user chooses a result with a lower score, a calibration of understanding can occur.

A qualifier is a name-value pair, where a set of attributes corresponds to a set of values. A decision factor is an abstraction of these qualifiers into coarsely defined categories. There may be a number of decision factor definitions, each having several categories. The system and method of the present invention works, in part, on a C3/T9/B5/I8 decision model of consumer behavior, as described in more detail below.

The C3, T9, and B5 decision factor models are used directly in journeys. A journey can begin before you leave your home and end when you return. A journey incorporates all travel and destination activities. A journey encompasses many venues, including fly, drive, stay, see, and visit, and the like. A C3 decision model definition has three categories: cost, comfort, and convenience, and abstracts a traveler's behavior in three distinct decision categories. A T9 decision model definition has nine categories: location, cost, time, brand, amenity, service class, service type, rating, and convenience, and is what makes up the user's travel-related distinctiveness in decision-making. A B5 decision model definition has five categories: vendor, cost, location, time, and service class, and represents a business traveler.

The I8 decision factor model is used indirectly in packages. An I8 decision model definition has eight categories: cost, location, climate, time, recreation, occasion, environment, and relation, and expresses a user's decision-making from the interest viewpoint. A package is derived from interest models (e.g. I8). It is implicit. It does not map to qualifiers and quantifiers. A journey is similar to “where do you want to go?” and a package is similar to “what do you want to do?” For example, a user might be interested in a package where the climate is cold, the time is foliage season, recreation is hiking, and the occasion is a school vacation. The resultant set of recommended packages might suggest a particular Inn in New Hampshire as the top score. For journeys and packages, the system and method of consumer modeling may also include travel-related products from outside of the GDS.

As seen in FIG. 10, a persona 2 is derived from a consumer's purchase type. In the travel planning context, a purchase type, or journey type 4, could be business travel, leisure travel, or a mixture of the two. A behavior 20 is a choice of a qualifier 10 under a certain condition, which is defined as behavior type 22. Multiple scores can be calculated for each behavior type 22.

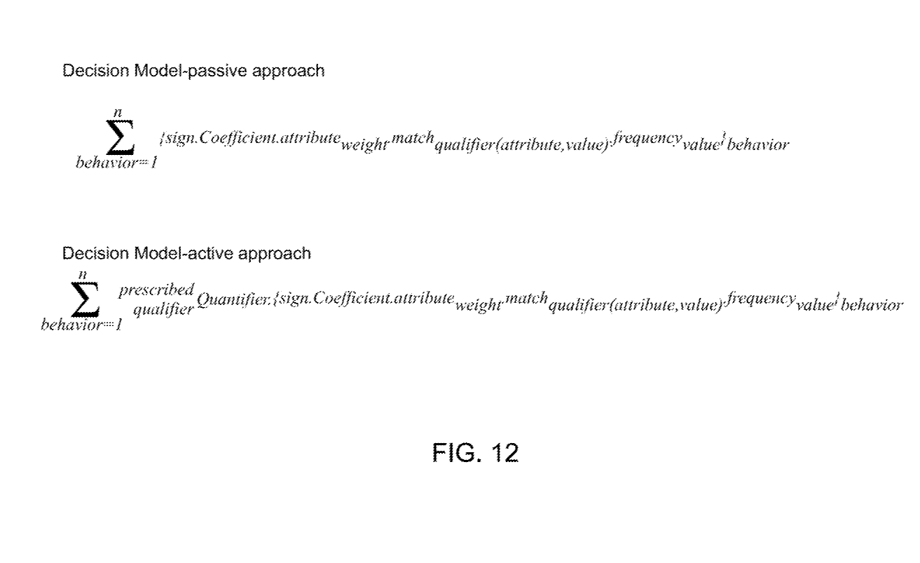

There are several varieties of scoring functions utilized by the scoring engine of the present invention, including active and passive Decision Factor (“DF”) approaches, and a coordinated multi-factor score, or WUHU score (“WS”). A passive DF approach uses a qualifier-based approach, and an active DF approach uses a quantifier-based approach. See FIG. 12.

An example of a passive DF approach is the SUM(ti*Bi), wherein i is the behavior type, t is the type coefficient and B is the normalized count of matches between the purchase items qualifier and the consumer's qualifiers. A match can be defined as exact, in a range, inequality, and the like. The more qualifiers a consumer “touches,” the more the normalized behavior value increases. Of course, a qualifier has an importance defined in its attribute.

The WS=r*R+t*T+1*L+(d1*D1+d2*D2 dm*Dm)±b*B. Wherein R, T, B, L and D represent realized, transient (fiddling), bootstrapping, rewards, and direct (entry and choice) behavior, respectively. There are many direct behavior types, including favorite (like-it), blacklist (hate-it), exclude-it-forever, make-it-default, hide-it, and the like. The variables r, t, h, l, and d are the weight coefficients for realized, transient (fiddling), bootstrapping, rewards, and direct behavior, respectively.

The system continues to learn about the user during the travel planning experience. When a user views a result and fine tunes criteria, this information is used to modify the results presented for the user's selection. The system can incorporate numerous metrics, including proximity to services, including airports, restaurants, museums, and the like. The system incorporates known values such as AAA ratings, room attributes, amenities, and the like.

If the user likes a specific brand, they can indicate that they like that brand. The columns in the display can be sortable, so if the user would like to sort a specific item, such as cost, he can then sort on all the cost options. If the user wants to refine what is displayed, or provide more details, he can click the fiddle bar and provide additional input.

In one embodiment, the system and method utilizes fuzzy logic as a way of matching results. Fuzzy logic allows for approximate values and inferences as well as incomplete or ambiguous data (fuzzy data) as opposed to only relying on crisp data (binary yes/no choices). For example, cheaper, cheapest, earlier, earliest, and the like. Fuzzy logic is able to process incomplete data and provide approximate solutions to problems other methods find difficult to solve.

The system and method makes it easy for a traveler to experience traveling by organizing the travels into destination and journey collections, plan a new journey and to manage past, current, and saved journeys. Within the system, all journeys can also be grouped into collections. A collection can be a preferred provider (like a hotel), a destination (such as Tampa), or a set of journeys that has a common purpose (like all the business trips a user would take, or geography cased criteria etc.).

The system incorporates traveler behavior under personas. A persona can be predefined such as business, leisure or custom-defined such as traveling with spouse, family outing, my golfing expedition, mancation, etc. Source of additional behavior can be obtained from social media when and where it is allowed and appropriate.

The system also establishes templates that capture traveler behavior in a given situation. Templates are snapshots of prescribed behavior. These are derived from existing journeys, travelled or not. A template can also be enriched by adding direct behaviors, for instance; a user may prefer a type of accommodation (4 star hotels), a particular car company or carrier, as well as a preferred airport for departures. This data could be used to facilitate future journeys by translating the criteria and applying it to new destinations based on the scoring of the various qualifiers associated with the behavior type. For example, one could select a previous trip to NYC and create a behavior template, and apply it to an upcoming journey to Paris.

These templates could even be shared between travelers by inviting other travelers to view private data. This sharing is initiated by the inviter and has to be accepted by the invitee who explicitly defines what needs to be shared. The system by default does not share private travel data among the travelers.

The ultimate goal of the system is to provide a just-in-time click travel planning experience reducing the steps and complexity by understanding and remembering the traveler. Therefore, the system requires the traveler to enter the minimum amount of information such as dates, purpose and/or destination and it automatically selects the best fit for the traveler.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A system for modeling consumer behavior comprising,
at least one input mechanism configured to receive and send user-related information;
a central processing unit configured to receive and send user-related information and supply data relating to travel and entertainment, wherein the central processing unit comprises a scoring engine and at least one database for storing information relating to travel and entertainment;
a scoring engine configured to categorize user-related information based on decision models and compare the categorized user-related information to the information stored in the at least one database thereby creating a list of results; and
at least one output mechanism configured to receive and display the list of results, wherein the user selects a result to add to a journey.

2. The system for modeling consumer behavior of claim 1, wherein the at least one input mechanism comprises a computing device.

3. The system for modeling consumer behavior of claim 1, wherein the at least one output mechanism comprises a computing device.

4. The system for modeling consumer behavior of claim 1, wherein the central processing unit is configured to update and store the journey and related information from search to purchasing.

5. The system for modeling consumer behavior of claim 4, wherein the central processing unit is configured to notify the user of gaps in the journey via the output mechanism.

6. The system for modeling consumer behavior of claim 5, wherein the central processing unit is configured to provide a list of possible results to fill a gap in the journey.

7. The system for modeling consumer behavior of claim 1, wherein the scoring engine comprises a scoring function selected from the group consisting of a passive decision model approach, an active decision factor approach, and a coordinated multi-factor approach.

8. The system for modeling consumer behavior of claim 1, wherein the scoring function comprises the WUHU score and confidence level.

9. The system for modeling consumer behavior of claim 8, wherein the WUHU score and confidence level uses realized, transient, bootstrapping, rewards, and direct behavior values to evaluate a result.

10. The system for modeling consumer behavior of claim 9, wherein the direct behavior comprises options ranging from like-it, hate-it, exclude-it-forever, make-it-default, hide-it, and the like, wherein the designations map into an importance value scale between −1 and 1.

11. The system for modeling consumer behavior of claim 1, wherein the decision models are selected from the group consisting of an initial set, C3, T9, B5 and I8.
